(19) United States
(12) Patent Application Publication
(10) Pub. No.: US 2003/0178008 A1
(43) Pub. Date: Sep. 25, 2003

(54) WARREN CYCLE INTERNAL COMBUSTION ENGINE

(76) Inventor: Edward Lawrence Warren, West Melbourne, FL (US)

Correspondence Address: Edward L. Warren, 3912 Snowy Egret Dr., West Melbourne, FL, 32904, US

(21) Appl. No.: 10/103,174

(22) Filed: Mar. 22, 2002

(51) Int. Cl. F02G 5/00

(52) U.S. Cl. 123/543

(57) ABSTRACT

The Warren cycle engine operates on the Warren Cycle, and is a two stroke, internal combustion, reciprocating, regenerated engine made up of a number of similar working units. Each working unit is comprised of cylinder 12 that is closed at one end by cylinder head 4 and contains power piston 18 that is connected to power output shaft 22. Movable wall 11 is provided to suck in the working fluid and push the exhaust out of cylinder 12. As the exhaust moves out of the engine, it gives up heat to regenerator 10. During the heating portion of the cycle movable wall 11 pushes the compressed air through regenerator 10 and recaptures the heat left by the exhaust gases. Movable wall 11 can move between power piston 18 and cylinder head 4, and means are provided to accomplish this movement at the appropriate times during the engine's operating cycle. Means are also provided for the introduction of fuel into cylinder 12 during the heating part of the cycle. The engine can be operated with complete expansion of the air-fuel charge, or it can be operated in a high power output mode, depending on the timing of the closing of exhaust valve 6. In an alternate embodiment of this invention the engine operates with rotating regenerator 30. The Warren Cycle is an engine cycle where compression is adiabatic, heat is added at constant volume, expansion is adiabatic and complete, and the exhaust heat is captured and returned to the compressed air.

### BACKGROUND

1. Field of Invention

The present invention relates to a thermally regenerated, reciprocating, two stroke internal combustion engine that stores the exhaust heat and returns it to the engine cycle to do work.

2. Description of Prior Art

Thermal regeneration is the capturing of waste heat from a thermodynamic cycle (or a heat engine operating on some thermodynamic cycle), and the utilization of that energy within the cycle or engine to improve the cycle or engine's performance. This is commonly done with many heat engines including Stirling engines, gas turbines, and Rankine cycle devices. In a gas turbine the exhaust heat coming out of the exhaust is transferred to the air leaving the compressor and going into the combustor. This way it is not necessary to add as much heat (fuel) in the combustor to raise the air temperature to the desired turbine inlet temperature. This means that the same work is accomplished but less fuel is used. The automobile and truck gas turbines use rotating regenerators to transfer energy from the exhaust gases to the compressed air.

The approach taken by previous inventors who attempted to incorporate regeneration into reciprocating internal combustion engines was to try to regenerate using a movable regenerator attached to the movable wall. The most successful design is: Two Stroke Regenerative Engine. Warren (2000, U.S. Pat. No. 6,116,222). The drawback to this design is moving the mass of the regenerator, and it is difficult to cool the power piston. Other differences exist between that engine and the regenerated engine disclosed herein. All of these are discussed in greater detail in the section entitled “Detailed Description of the Invention”.

### SUMMARY

The Warren Cycle is an engine cycle where compression is adiabatic, heat is added at constant volume, expansion is adiabatic and complete, and the exhaust heat is captured and returned to the compressed air. The Warren cycle engine operates on the Warren Cycle, and is a two stroke, internal combustion, reciprocating, regenerated engine made up of a number of similar working units. Each working unit is comprised of a cylinder that is closed at one end by a cylinder head and contains a movable power piston that is connected to a power output shaft. A movable wall is provided to suck in the working fluid and push the exhaust out of the cylinder. As the exhaust moves out of the engine, it gives up heat to a regenerator. During the heating portion of the cycle the movable wall pushes the compressed air through the regenerator and recaptures the heat left by the exhaust gases. This movable wall can move between the power piston and the cylinder head, and means are provided to accomplish this movement at the appropriate times during the engine's operating cycle. Means are also provided for the introduction of fuel into the cylinder during the heating part of the cycle. The engine can be operated with complete expansion of the air-fuel charge, or it can be operated in a high power output mode, depending on the timing of the closing of the exhaust valve. In an alternate embodiment of this invention the engine operates with a rotating regenerator.

### OBJECTS AND ADVANTAGES

Several objects and advantages of the regenerative engine are:

(a) The engine saves the heat from the exhaust gases and releases the heat to the compressed air.

(b) The engine can be operated so that the charge is almost fully expanded.

(c) The power piston stays cool.

### DRAWING FIGURES

FIG. 1 shows the engine at the end of the expansion part of the cycle, and at the start of the inlet and exhaust part of the cycle.

FIG. 2 shows the engine at the end of the inlet and exhaust part of the cycle, and at the start of the compression part of the cycle.

FIG. 3 shows the engine at the end of the compression part of the cycle, and at the start of the heating part of the cycle.

FIG. 4 shows the engine at the end of the heating part of the cycle, and at the start of the expansion part of the cycle.

FIG. 5 shows the alternate embodiment of the engine at the end of the expansion part of the cycle, and at the start of the inlet and exhaust part of the cycle.

FIG. 6 shows the alternate embodiment of the engine at the end of the inlet and exhaust part of the cycle, and at the start of the compression part of the cycle.

FIG. 7 shows the alternate embodiment of the engine at the end of the compression part of the cycle, and at the start of the heating part of the cycle.

FIG. 8 shows the alternate embodiment of the engine at the end of the heating part of the cycle, and at the start of the expansion part of the cycle.

### REFERENCE NUMERALS IN DRAWINGS

2 air inlet port

4 cylinder head

6 exhaust valve

8 exhaust pipe

10 regenerator

11 movable wall

12 cylinder

14 fuel injector

16 igniter

18 power piston

20 connecting rod

22 power output shaft

26 cam

28 valve cams

30 rotating regenerator

32 spring

34 regenerator isolation valve

36 regenerator isolation port

38 gearbox

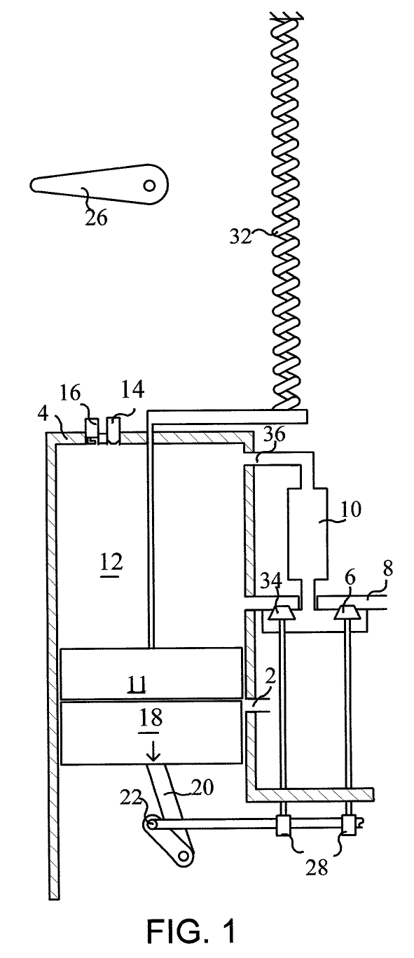

Description—FIGS. 1 to 4—Preferred Embodiment

This invention is a two stroke, reciprocating, internal combustion engine with regenerator 10, and employing a movable wall 11. The preferred embodiment of this invention employs a two stroke cycle divided into four parts. The first part is the intake and the exhaust part. The second is the compression part, the third is the heating part, and the fourth is the expansion part. The intake and exhaust part is from about 85% of the downward travel of power piston 18 to about 15% of the travel back up (or as measured by power output shaft 22 rotation from about 135° to about 225°). The compression part is from about 15% of the travel back up of power piston 18 (225°) to about top dead center. The heating part is from about 85% of the travel back up of the power piston 18 (315°) to about 15% of the downward travel of power piston 18 (45°). The expansion part is from about top dead center to about 85% of the downward travel of power piston 18 (135°). The heating part of the cycle overlaps both the end of the compression part and the start of the expansion part of the cycle. The above positions are all estimates and are given for descriptive purposes only. The actual position a part of the cycle may begin or end at may be different from those set out above.

In the preferred embodiment of this invention, movable wall 11 makes two strokes each cycle, a stroke away from power piston 18, which is the air intake, exhaust, and regenerative cooling stroke (exhaust gases cool); and a stroke towards power piston 18 which is the regenerative heating stroke (working fluid heats).

The regenerative cooling stroke begins with movable wall 11 adjacent to power piston 18 and ends with movable wall 11 adjacent to cylinder head 4. During the regenerative cooling stroke movable wall 11 moves up (away from power piston 18) forcing the hot exhaust gases through regenerator 10, and regenerator 10 absorbs heat from the exhaust gases (cooling the exhaust gases). As movable wall 11 is making the regenerative cooling stroke it is also forcing out exhaust gases and sucking in fresh air.

The regenerative heating stroke starts with movable wall 11 adjacent to cylinder head 4 and ends with movable wall 11 close to and moving down with power piston 18. During the regenerative heating stroke movable wall 11 is moved down pushing the working fluid trapped between cylinder head 4 and power piston 18 through regenerator 10 and heat is transferred to this working fluid (heating the working fluid).

The working fluid that is expected to be employed in this invention is air. However, this working fluid could be any mixture of gases, liquids, and solids that can undergo an exothermic chemical reaction with the fuel. The working fluid that is introduced into the cylinder is sometimes referred to as fresh working fluid, or as the charge. The fresh working fluid can contain some residual reaction products that are trapped in the cylinder after the exhaust means close, or that are added to it in the intake manifold (i.e. exhaust gas recirculation). After the combustion (or other exothermic reaction which provides the power for the engine) the working fluid is referred to as spent working fluid, exhaust fluid, or exhaust gases. The fuel may be any solid, liquid, gas, or combinations of these that can undergo an exothermic reaction with the fresh working fluid.

When movable wall 11 is not moving, it is adjacent to cylinder head 4. “adjacent to” means that movable wall 11 is in contact with or as close as possible to cylinder head 4 given the mechanical and structural constraints associated with the coming together of rapidly moving objects. “Close to” is synonymous with “adjacent to”. While it is advantageous to minimize some internal volumes that are not swept by movable wall 11, it must be recognized that small clearance regions or volumes will probably be necessary to prevent damaging impacts between components and for clearances between moving components. Examples of such clearance regions or volumes include small gaps between movable wall 11 and cylinder head 4 when movable wall 11 is adjacent to it, the clearance gap between the periphery of movable wall 11 and cylinder 12 wall, and other non-heated or partially heated volumes. There is internal volume between power piston 18 and movable wall 11 as the two come together.

FIGS. 1-4 illustrate schematically an internal combustion engine suitable for practice of this invention. Only one set of components for such an engine is illustrated; however, what is illustrated will function as a complete engine if it has an inertial load. It will be understood that this is merely representative of one set of components. A plurality of such structures joined together would make up a larger engine. Other portions of the engine are conventional. Thus, the bearings, seals, cam shafts, etc. of the engine are not specifically illustrated. The valves illustrated are but one type out of many that could be used.

The preferred embodiment of a two stroke regenerative engine can be operated with supercharging or without supercharging. Cylinder 12 is closed at one end by a cylinder head 4 and contains fuel injector 14; power piston 18 which is connected to power output shaft 22 by a connecting rod 20 (for converting the linear motion of the piston to the rotating motion of the shaft); and igniter 16. (All of the engine embodiments presented herein utilize a spark plug for ignition of the fuel. While recognizing that this igniter may only be required for starting, such an ignition source is included in every embodiment and claim.). Cylinder 12 further contains air inlet port 2. When air inlet port 2 is uncovered it allows air to be sucked into the cylinder volume located between power piston 18 and movable wall 11.

Fuel injector 14 can be an off the shelf injector that injects fuel into cylinder 12. Igniter 16 can be on off the shelf igniter that ignites the fuel, or it can be a catalytic burner. The expanding gases exert a force on power piston 18, (a cylindrical piston that can move up and down in cylinder 12). That force, exerted on power piston 18 moving it down, is transmitted via connecting rod 20 and power output shaft 22 to a load (not shown). Exhaust valve 6 allows the exhaust gases to leave the engine, and regenerator isolation valve 34 controls the flow through regenerator 10. Valve cams 28 on power output shaft 22 operate both valves.

Movable wall 11 moves up and down in cylinder 12 and it pushes air or exhaust gases from the space that it moves into. When movable wall 11 moves up regenerator isolation valve 34 is closed and does not allow any air to pass, exhaust valve 6 is open and exhaust air moves from the space between movable wall 11 and cylinder head 4 through regenerator 10 and exhaust valve 6 out of the engine. When movable wall 11 is moving down exhaust valve 6 is closed and does not allow any air to pass, regenerator isolation valve 34 is open and air moves through regenerator 10. Regenerator 10 is made from a permeable material such that when the exhaust gases flow through it, the material absorbs heat from the exhaust gases. When the compressed air flows through it, the permeable material gives up heat to the compressed air.

The means to move movable wall 11 is cam 26 driven from power output shaft 22 by gearing and a cam shaft that are not shown. The speed ratio between cam 26 and power output shaft 22 is 1:1, and the angular displacement between cam 26 and power output shaft 22 is approximate and must be determined for the detail design of each engine. Other means can be used to move movable wall 11, such as an actuator, a cam on power output shaft 22, a push rod, and a rocker arm (not shown). These other means can be applied to movable wall 11 from above or below power piston 18. The means can be hydraulic, pneumatic, electrical, mechanical, or any combination of them that will move movable wall 11 when and as required.

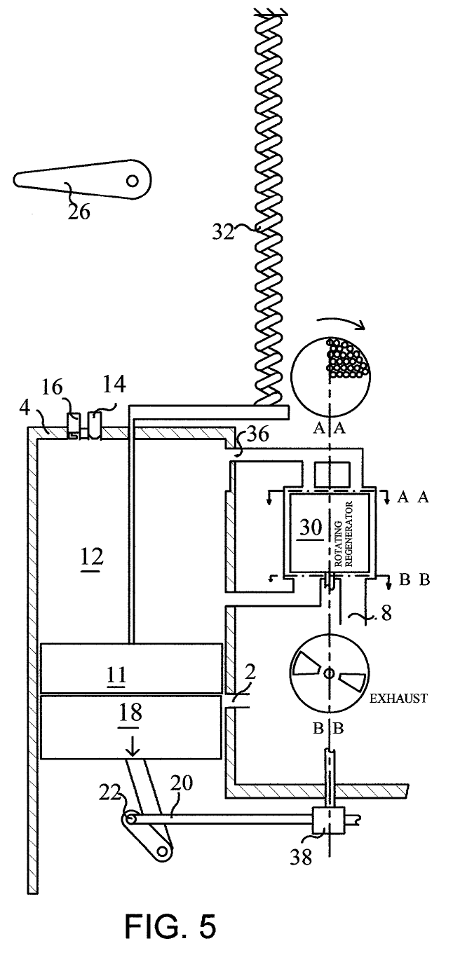

FIGS. 5-8 First Alternate Embodiment

FIGS. 5 through 8 show the first alternate embodiment of the invention. It is the same as the preferred embodiment of the invention with regenerator isolation valve 34, exhaust valve 6, and regenerator 10 replaced by rotating regenerator 30 driven through gearbox 38.

FIGS. 1 to 4—Operation of Preferred Embodiment

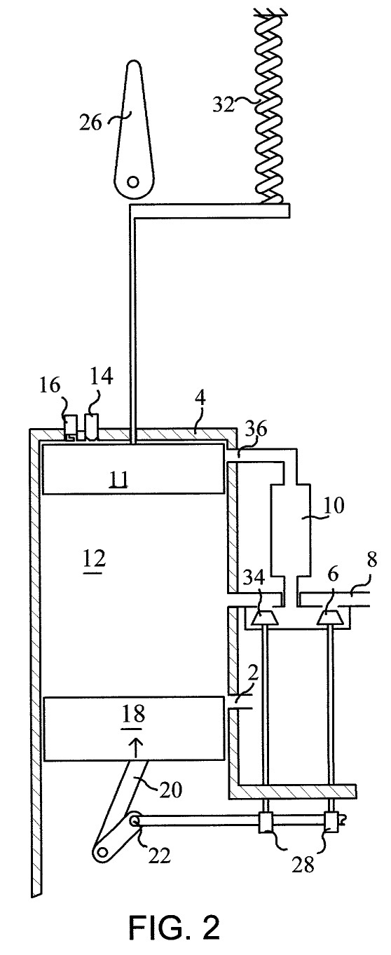

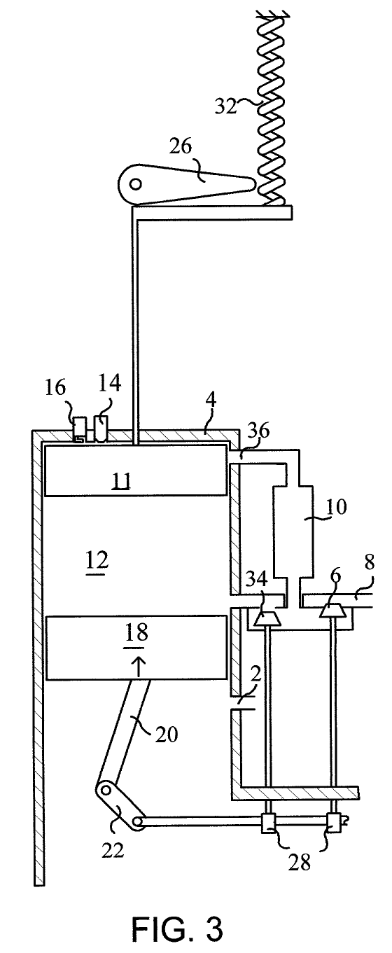

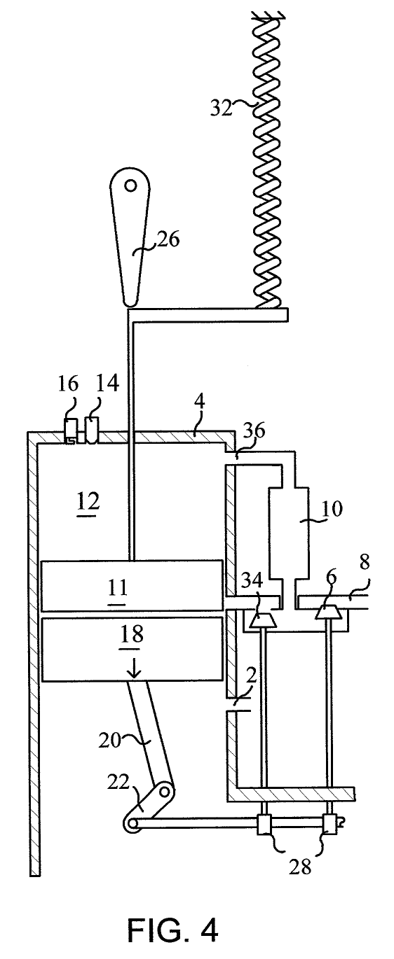

FIGS. 1 to 4 present the sequence of steps or processes occurring in a two stroke regenerative engine. The air intake and exhaust part of the cycle takes place between FIGS. 1 and 2. The compression part of the cycle takes place between FIGS. 2 and 3. The heating part of the cycle takes place between FIGS. 3 and 4. The expansion part of the cycle takes place between FIGS. 4 and 1.

FIG. 1 shows power piston 18 at about 85% of downward travel (135°). The engine has completed the expansion part of the cycle and is about to start the intake and exhaust part. Air inlet port 2 is covered, regenerator isolation valve 34 is closed, exhaust valve 6 is closed, movable wall 11 is just above power piston 18, and spring 32 is stretched.

Between FIG. 1 and FIG. 2 exhaust valve 6 opens, air inlet port 2 is uncovered, spring 32 urges movable wall 11 up to cylinder head 4 where it covers regenerator isolation port 36. While movable wall 11 is moving up exhaust gases are moving through regenerator 10, heating up regenerator 10 on their way out exhaust valve 6. Also while movable wall 11 is moving up, it sucks in fresh working fluid through air inlet port 2. Power piston 18 continues down to the bottom of cylinder 12 and comes up again to about 15% of upward travel (225°). Regenerators isolation valve 34 opens.

In FIG. 2, there is a maximum charge of fresh air between cylinder head 4 and power piston 18 which is at about 15% of its upward travel (225°). Air inlet port 2 is covered, regenerator isolation port 36 is covered, regenerator valve isolation 34 is open and exhaust valve 6 is open.

Between FIG. 2 and FIG. 3 power piston 18 continues to move up in cylinder 12, and exhaust valve 6 closes. The sooner it closes the higher the pressure ratio, and the later it closes the lower the pressure ratio. The setting of when exhaust valve 6 closes determines the pressure ratio of the engine. Therefore, the pressure ratio of the engine does not have to be the same as the expansion ratio. The engine can be operated to complete expansion of the charge. After exhaust valve 6 closes compression begins, and power piston 18 continues to move up in cylinder 12 and will come up to about 85% of upward travel (315°).

In FIG. 3, power piston 18 is at about 85% of its upward travel (315°), regenerator isolation valve 34 is open, exhaust valve 6 is closed, and movable wall 11 is still adjacent to cylinder head 4.

Between FIG. 3 and FIG. 4 power piston 18 will continue up to top dead center and will come down again to about 15% of downward travel (45°), movable wall 11 is urged down by cam 26, spring 32 is stretched, and compressed air is moved from the space between movable wall 11 and power piston 18 through regenerator 10, where it heats up, it then goes into the space between movable wall 11 and cylinder head 4. Fuel is added and ignited.

In FIG. 4. Power piston 18 is at about 15% of its downward travel (45°), movable wall 11 is adjacent to power piston 18, and both are being forced down by gas pressure forces. Spring 32 is stretched.

Between FIG. 4 and FIG. 1 power piston 18 and movable wall 11 move down to about 85% of power piston's 18 downward travel (135°), power output takes place, regenerator isolation valve 34 closes, and spring 32 stretches further.

The cycle repeats.

FIGS. 5 to 8—Operation of the First Alternate Embodiment

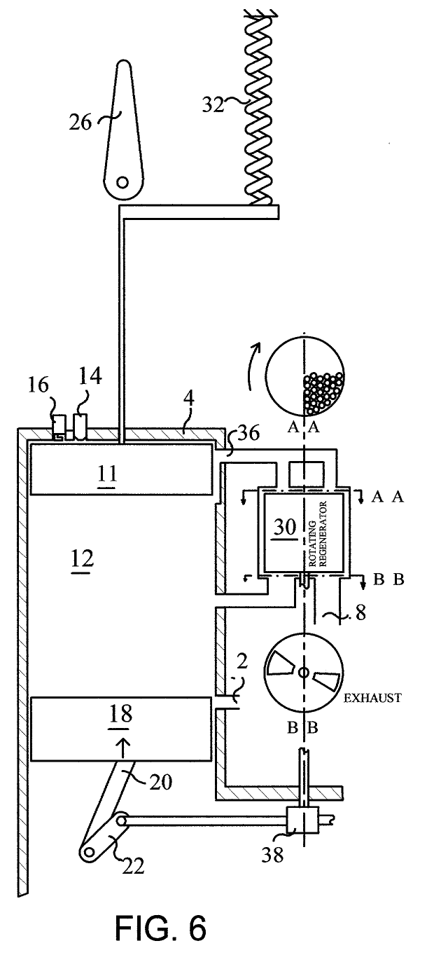

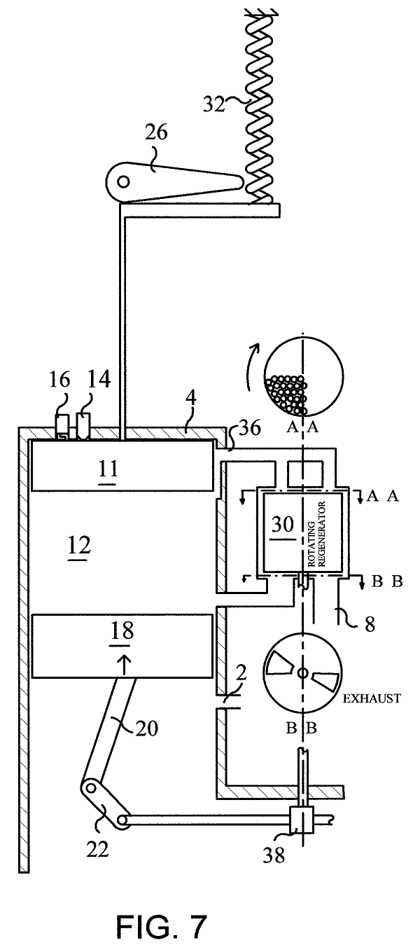

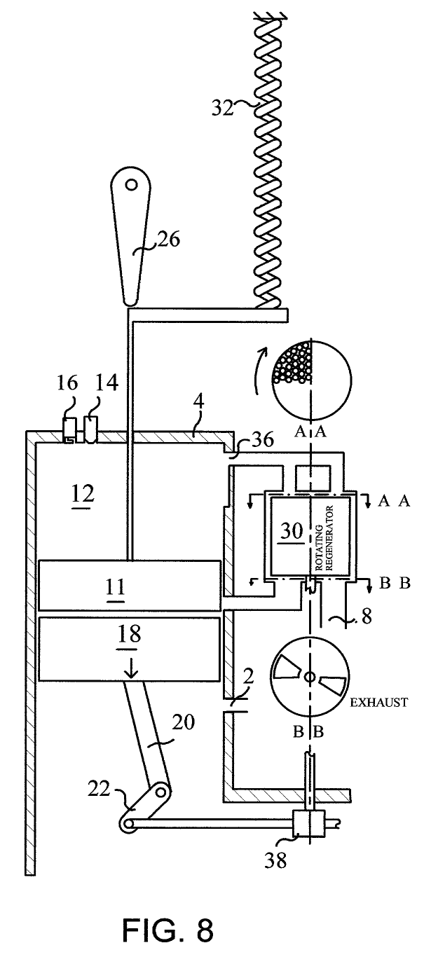

FIGS. 5 to 8, present the sequence of steps or processes occurring in the first alternate embodiment of the two stroke regenerative engine. The air intake and exhaust part of the cycle takes place between FIGS. 5 and 6. The compression part of the cycle takes place between FIGS. 6 and 7. The heating part of the cycle takes place between FIGS. 7 and 8. The expansion part of the cycle takes place between FIGS. 8 and 1.

FIG. 5 shows power piston 18 at about 85% of downward travel (135°). The engine has completed the expansion part of the cycle and is about to start the intake and exhaust part. Air inlet port 2 is covered, movable wall 11 is just above power piston 18, and spring 32 is stretched. Rotating regenerator 30 has not rotated to line up with exhaust pipe 8, but is about to start lining up and allowing exhaust gases through.

Between FIG. 5 and FIG. 6 air inlet port 2 is uncovered, rotating regenerator 30 rotates, and spring 32 urges movable wall 11 up to cylinder head 4. While movable wall 11 is moving up exhaust gases are moving through rotating regenerator 30, heating up rotating regenerator 30 on their way out exhaust pipe 8. Also while movable wall 11 is moving up, it sucks in fresh working fluid through air inlet port 2. Power piston 18 continues down to the bottom of cylinder 12 and comes up again to about 15% of upward travel (225°).

In FIG. 6, there is a maximum charge of fresh air between cylinder head 4 and power piston 18 which is at about 15% of its upward travel (225°). Air inlet port 2 is covered, and rotating regenerator 30 has rotated so that only a small portion is still lined up with exhaust pipe 8.

Between FIG. 6 and FIG. 7 power piston 18 will continue to move up in cylinder 12 compressing the air as it comes up to about 85% of upward travel (315°). The sooner rotating regenerator 30 rotates and closes off the exhaust the higher the pressure ratio, and the later it closes off the exhaust the lower the pressure ratio. The setting of when rotating regenerator 30 rotates and closes off the exhaust determines the pressure ratio of the engine. Therefore, the pressure ratio of the engine does not have to be the same as the expansion ratio. The engine can be operated to complete expansion of the charge. After rotating regenerator 30 rotates and closes off the exhaust compression begins, and power piston 18 continues to move up in cylinder 12 and will come up to about 85% of upward travel (315°).

In FIG. 7, power piston 18 is at about 85% of its upward travel (315°), rotating regenerator 30 has rotated to start to line up with openings to cylinder 12, and movable wall 11 is still adjacent to cylinder head 4.

Between FIG. 7 and FIG. 8 rotating regenerator 30 has rotated and lines up with openings to cylinder 12, power piston 18 will continue up to top dead center and will come down again to about 15% of downward travel (45°), movable wall 11 is urged down by cam 26, spring 32 is stretched, and compressed air is moved from the space between movable wall 11 and power piston 18 through rotating regenerator 30, where it heats up, into the space between movable wall 11 and cylinder head 4. Fuel is added and ignited.

In FIG. 8. rotating regenerator 30 has rotated so that it is still lined up with openings to cylinder 12, power piston 18 is at about 15% of its downward travel (45°), movable wall 11 is adjacent to power piston 18, and both are being forced down by gas pressure forces. Spring 32 is stretched.

Between FIG. 8 and FIG. 5 power piston 18 and movable wall 11 move down to about 85% of power piston's 18 downward travel (135°), power output takes place, rotating regenerator 30 has rotated so as not to line up openings to cylinder 12, spring 32 stretches further, and air inlet port 2 is uncovered.

The cycle repeats.

### CONCLUSION

Accordingly, the reader will see that the two stroke regenerative engine meets the following objects and advantages:

(a) The engine saves the heat from the exhaust gases and releases the heat to the compressed air

(b) The engine can be operated so that the charge is almost fully expanded.

(c) The power piston stays cool.

Although the description above contains much specificity, this should not be construed as limiting the scope of the invention but as merely providing illustrations of some of the presently preferred embodiments of this invention.

Thus the scope of the invention should be determined by the appended claims and their legal equivalents, rather than by the examples given.

I claim:

1. A two strokes internal combustion, reciprocating engine having a number of similar working units, each working unit comprising:
a) a cylinder, closed at one end by a cylinder head and containing a movable power piston which moves in a reciprocating manner and is connected to a power output shaft;
b) a movable wall located within said cylinder and between said power piston and said cylinder head, said movable wall can be moved between said power piston and said cylinder head;
c) an air inlet port;
d) a thermal regenerator;
e) a means to isolate said thermal regenerator from said cylinder;
f) an actuator means for moving said movable wall during predetermined times during the engine's operating cycle;
g) a heat input means for increasing the molecular activity of the compressed gases.
h) an exhaust means;

2. An engine as recited in claim 1 wherein said thermal regenerator is fixed.

3. An engine as recited in claim 2 wherein said means to isolate said thermal regenerator from said cylinder is a regenerator isolation valve and a regenerator port.

4. An engine as recited in claim 1 wherein said thermal regenerator is rotated.

5. An engine as recited in claim 4 wherein said means to isolate said thermal regenerator from said cylinder is said rotating regenerator.

6. An engine as recited in claim 1 wherein said actuator means for moving said movable wall during predetermined times during the engine's operating cycle is a cam and a spring;

7. An engine as recited in claim 1 wherein said heat input means is a fuel injector and igniter.

8. An engine as recited in claim 1 wherein said heat input means is a fuel injector and catalytic burner

9. A process for operating the engine of claim 1 having the following steps:
a) from when said power piston uncovers said air inlet port and moves through its bottom dead center position and moves back up to said air inlet port; air intake, exhaust heat capture by said thermal regenerator, and exhaust occurs;
b) after said power piston covers said air inlet port, said power piston continues to move up exhausting air, until said exhaust means closes;
c) after said exhaust means closes, the air in said cylinder is compressed;
d) as said power piston approaches top dead center position near the conclusion of compression stroke said movable wall moves away from its position adjacent to said cylinder head toward said power piston, compressed air is forced from below said movable wall through said thermal regenerator to above said movable wall, as the compressed air moves through said thermal regenerator it heats up;
e) as said movable wall moves away from said cylinder head the space between said moving movable wall and said cylinder head is further heated by said heat input means;
f) said movable wall moves to the top of power piston while said power piston continues its expansion stroke, and the cycle repeats.

10. A process for operating the engine of claim 1 having the following steps:
a) air intake and exhaust,
b) capture of exhaust heat by said thermal regenerator during exhausting,
c) removal of air to adjust compression ratio,
d) compression at near adiabatic conditions,
e) heat added from said thermal regenerator and from said heat input means at near constant volume,
f) expansion at near adiabatic conditions.
